(19) United States
(12) Patent Application Publication
(10) Pub. No.: US 2021/0207302 A1
(43) Pub. Date: Jul. 8, 2021

(54) METHOD FOR MANUFACTURING EMBROIDERY PATTERN OR QUILTING PATTERN OF CLOTH FOR INTERIOR PANEL OF VEHICLE

(71) Applicants: Hae Bung Song, Boryeong-si (KR); Alexander Song-Ungaro, Seoul (KR); Yoon Jun Song, Seoul (KR)

(72) Inventor: Hae Bung Song, Boryeong-si (KR)

(21) Appl. No.: 17/093,796

(22) Filed: Nov. 10, 2020

(30) Foreign Application Priority Data
Jan. 2, 2020 (KR) 10-2020-0000359

(51) Int. Cl. D05C 5/02; D05C 17/00

(52) U.S. Cl. CPC D05C 5/02; D05C 17/00; D05C 3/02; D10B 2505/12; D05D 2303/00

(57) ABSTRACT

The present invention relates to a method for manufacturing a embroidery pattern or a quilting pattern of cloth for an interior panel of a vehicle, by which the embroidery pattern or the quilting pattern is manufactured individually or simultaneously on the cloth that is the interior panel for the vehicle by using a computer-aided embroidery machine.

### REFERENCE TO RELATED APPLICATIONS

This application claims the priority benefit of Korean Patent Application No. 10-2020-0000359 filed on Jan. 2, 2020, the entire contents of which are incorporated herein by reference.

### FIELD OF THE INVENTION

The present invention relates to a method for manufacturing a embroidery pattern or a quilting pattern of cloth for an interior panel of a vehicle, and more particularly to a method for manufacturing a embroidery pattern or a quilting pattern of cloth for an interior panel of a vehicle, by which the embroidery pattern or the quilting pattern is manufactured individually or simultaneously on the cloth that is the interior panel for the vehicle by using a computer-aided embroidery machine.

### BACKGROUND OF THE INVENTION

In recent years, interior panels of natural materials, that is, natural wood or natural leather have been increasingly applied to luxury cars.

The natural wood or natural leather has a unique texture or pattern, and the interior of a vehicle can be luxuriously decorated by applying the unique texture or pattern to an interior panel of a vehicle.

In addition, particularly, natural leather seats obtained by applying quilted leather to seats of a vehicle, that is, which have a stitch-shaped pattern on upper surfaces thereof have been increasingly applied.

When a quilted leather seat is applied to seats of a vehicle, a decoration effect due to unique textures and patterns of the natural leather itself and a decoration effect due to the stitch-shaped pattern are added so that the effect of decorating the interior of the vehicle can be further enhanced.

However, since the natural leather itself is high-priced and considerable costs are additionally required if the stitch-shaped pattern for quilting is formed, there is a problem that it is difficult to apply the natural leather to general vehicles other than luxurious cars due to the cost problem.

Accordingly, it can be seen that quilting pattern manufacturing methods for forming a stitch-shaped pattern on cloth of artificial leather, as disclosed in Korean Patent Nos. 10-1389333 and 10-1935983, have recently been tried.

However, conventionally, one head is mounted on a quilting machine for manufacturing a quilting pattern to form a quilting pattern having a simple shape.

Accordingly, since one head is mounted and used in the quilting machine, production speed is low and stitches of various patterns cannot be realized, since single model products are produced, they have a single color, and since it is difficult to realize quilting designs of various colors, the design performance for various quilting patterns may deteriorate.

### PRIOR TECHNICAL DOCUMENTS

1. Korean Patent No. 10-1389333

2. Korean Patent No. 10-1935983.

### SUMMARY OF THE INVENTION

In order to solve the above-described problems occurring in the prior art, the present invention provides a method for manufacturing a embroidery pattern or a quilting pattern of cloth for an interior panel of a vehicle, in which mass-production is made possible by individually or simultaneously forming a embroidery pattern or a quilting pattern on cloth (a product) that is an interior panel for a vehicle by using a computer-aided embroidery machine having a plurality of pattern heads, and an appealing embroidery pattern or quilting pattern can be realized by forming various patterns in various colors.

In order to solve the above-described problems, a method for manufacturing a embroidery pattern or a quilting pattern of cloth for an interior panel of a vehicle, by which the embroidery pattern or the quilting pattern is formed on the cloth of the interior panel for the vehicle by using a computer-aided embroidery machine having a plurality of pattern heads, in which a camera is installed, may include: installing threads having various colors and thicknesses for forming the embroidery pattern or the quilting pattern on the cloth in a plurality of thread hangers of the computer-aided embroidery machine; punching a design of the embroidery pattern or the quilting pattern, which is to be applied to the cloth; inputting the embroidery pattern or the quilting pattern, which is to be applied to the cloth, to a computer; displaying a coordinate recognition mark, which is scanned and recognized by the camera in correspondence to the embroidery pattern or the quilting pattern, on the cloth; supplying the cloth, on which the coordinate recognition mark is displayed, and positioning the cloth on a table; supplying the cloth positioning on the table to the pattern head to cause the camera to scan and recognize a portion, at which the embroidery pattern or the quilting pattern is to be formed by using the coordinate recognition mark, and transmit the scanned and recognized portion to the computer; selecting a corresponding thread, among the threads of various sizes hung on the thread hangers and setting the thread in a needle support by the computer based on a signal transmitted through the camera, to form the embroidery pattern or the quilting pattern on the cloth; forming the embroidery pattern or the quilting pattern on the cloth by operating the pattern head corresponding to the needle support, in which the thread for the embroidery pattern or the quilting pattern is set; and cutting the cloth, on which the embroidery pattern or the quilting pattern is formed.

According to an embodiment, in order to form the quilting pattern in a form, in which a plurality of holes are punched in the cloth, the camera may recognize the holes such that the quilting pattern is formed while avoiding the holes.

According to an embodiment, when the diameter of the holes punched in the cloth is 0.5 to 2.5 mm and a distance between the holes is 4 mm, the width of the quilting pattern may be 4 mm or less.

According to an embodiment, the thread for the quilting pattern may be a four-folded polyester filament inner bonding sewing yarn, in which four 70 denier main yarns and one 30 denier central yarn are coupled to each other in a circular form.

According to an embodiment, the thread for the embroidery pattern or the quilting pattern may be a single yarn or a folded yarn, the thickness of the thread for the embroidery pattern may be 70 to 350 denier, and the thickness of the thread for the quilting pattern may be 50 to 380 denier.

According to an embodiment, the width of stitches of the quilting pattern may be.

According to an embodiment, a size corresponding to the quilting pattern, and may be 0.2 to 10.0 mm.

According to an embodiment, the embroidery pattern or the quilting pattern may be formed on a product of the cloth by: inputting the size of the product, a portion of the embroidery pattern in the size, a portion of the quilting pattern in the size, the color of the embroidery pattern or the quilting pattern, and a cut portion of the product to the computer; scanning and recognizing corresponding portions of the product and transmitting the corresponding portions to the computer, by the camera; operating the pattern head by the computer that received transmitted data according to a manipulation to form the needle pattern or the quilting pattern having a color; and cutting the product, on which the embroidery pattern or the quilting patter is finished, through a cutter according to an operation of the computer.

According to the method for manufacturing a embroidery pattern or a quilting pattern of cloth for an interior panel of a vehicle according to the embodiment of the present invention, since a embroidery pattern or a quilting pattern can be formed individually or simultaneously by using the computer-aided embroidery machine having the plurality of pattern heads, not a single product but a plurality of pieces of cloth (products), which are interior panels for vehicles, can be simultaneously manufactured and thus mass-production is possible, and since the embroidery pattern or the quilting pattern can be formed in various patterns and colors, a product, in which appealing quilting is realized, can be manufactured.

### BRIEF DESCRIPTION OF THE DRAWINGS

The above and other aspects, features and advantages of the present invention will be more apparent from the following detailed description taken in conjunction with the accompanying drawings, in which:

FIG. 1 is a flowchart illustrating a method for manufacturing a embroidery pattern or a quilting pattern of cloth for an interior panel of a vehicle according to an embodiment of the present invention;

FIG. 2 is a partially perspective view illustrating a computer-aided embroidery machine for manufacturing a embroidery pattern or a quilting pattern of cloth for an interior panel of a vehicle according to the embodiment of the present invention;

FIG. 3 is a schematic side view illustrating a pattern head of the computer-aided embroidery machine;

FIGS. 4 and 5 are pictures depicting a product manufactured through the method for manufacturing a embroidery pattern or a quilting pattern of cloth for an interior panel of a vehicle according to the embodiment of the present invention; and

FIG. 6 is a picture depicting a product, in which a quilting pattern is formed on cloth, in which punches are punched, according to the embodiment of the present invention.

### DETAILED DESCRIPTION OF THE INVENTION

Hereinafter, a preferred embodiment of a method for manufacturing a embroidery pattern or a quilting pattern of cloth for an interior panel of a vehicle according to an embodiment of the present invention will be described in detail with reference to the accompanying drawings.

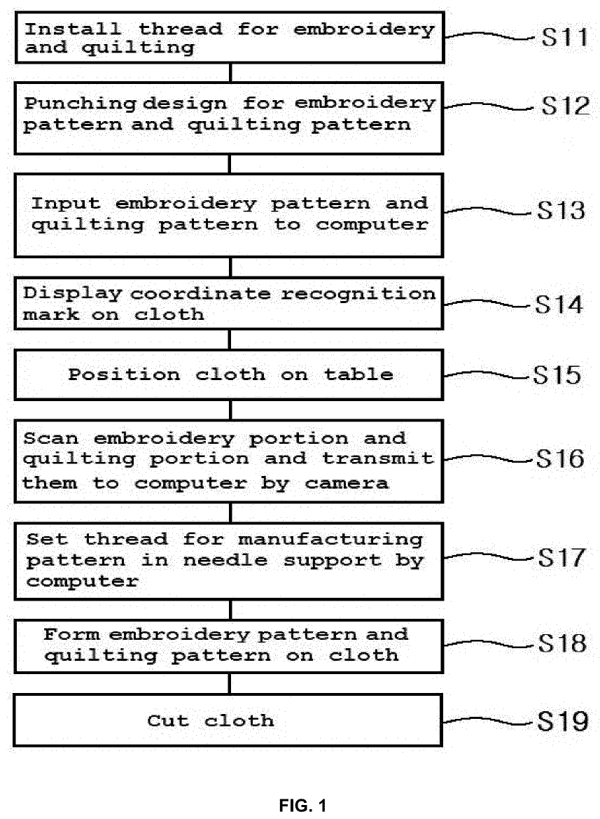

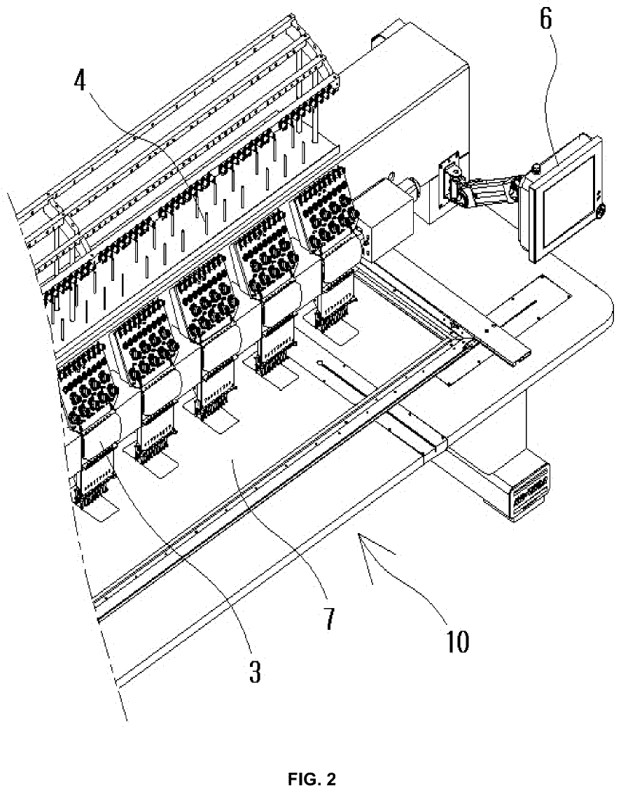

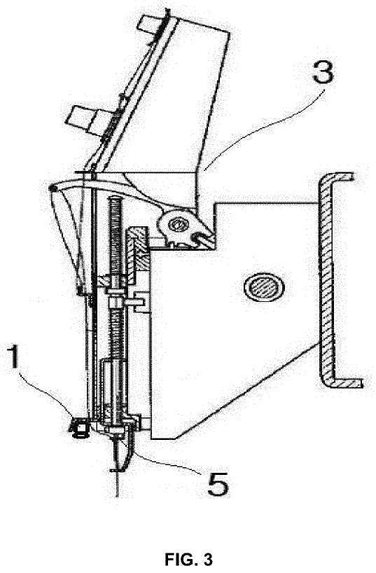

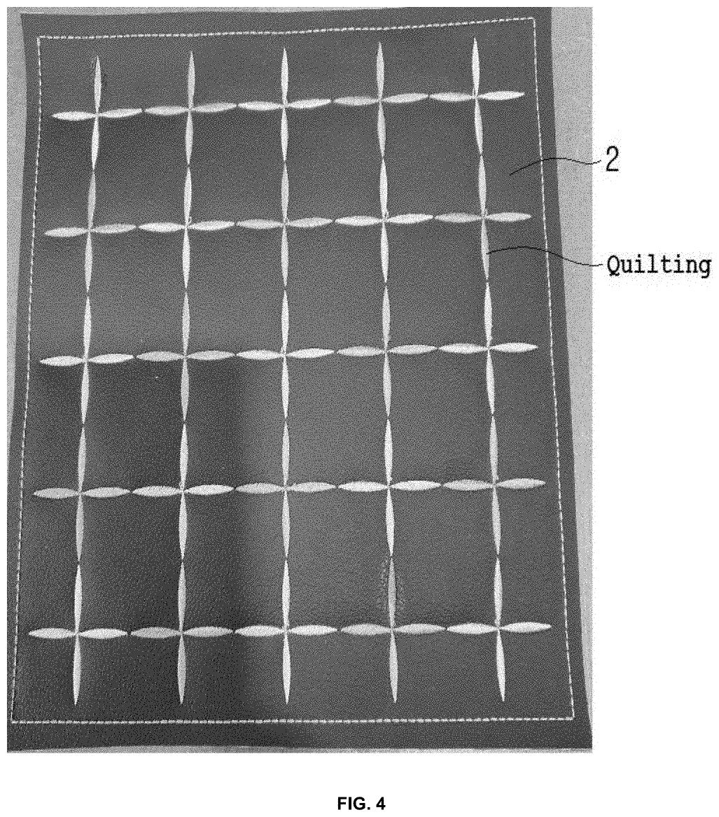

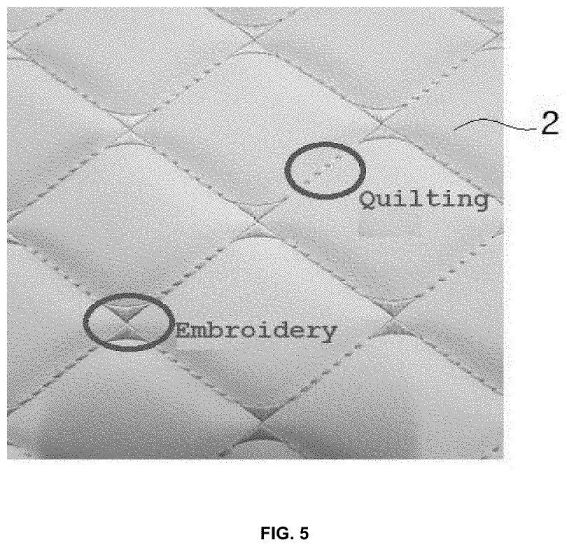

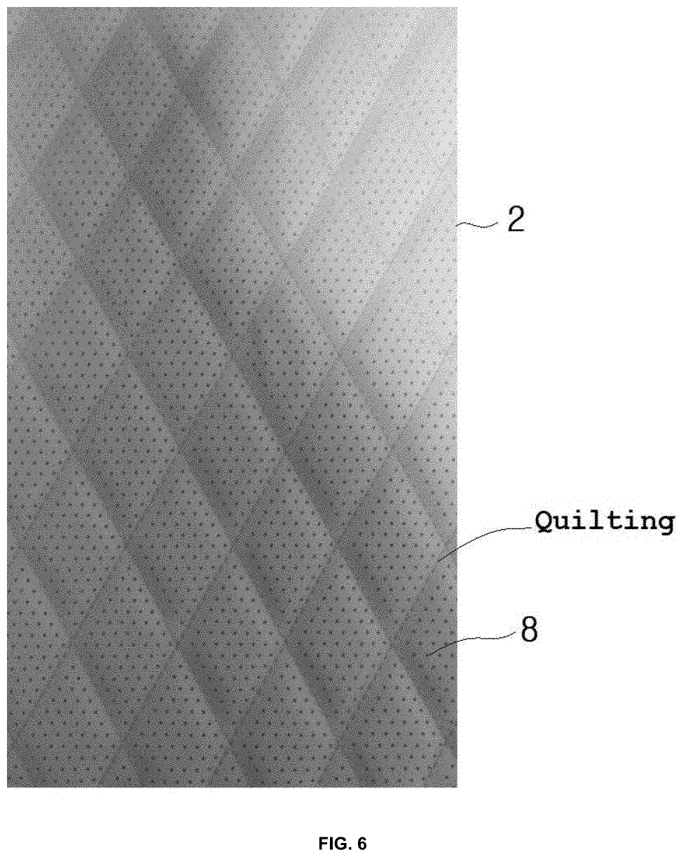

FIG. 1 is a flowchart illustrating a method for manufacturing a embroidery pattern or a quilting pattern of cloth for an interior panel of a vehicle according to an embodiment of the present invention. FIG. 2 is a partially perspective view illustrating a computer-aided embroidery machine for manufacturing a embroidery pattern or a quilting pattern of cloth for an interior panel of a vehicle according to the embodiment of the present invention. FIG. 3 is a schematic side view illustrating a pattern head of the computer-aided embroidery machine. FIGS. 4 and 5 are pictures depicting a product manufactured through the method for manufacturing a embroidery pattern or a quilting pattern of cloth for an interior panel of a vehicle according to the embodiment of the present invention. FIG. 6 is a picture depicting a product, in which a quilting pattern is formed on cloth, in which punches are punched, according to the embodiment of the present invention.

First, it should be noted that the same elements or the same components are denoted by the same reference numerals in the drawings. Further, in a description of the present invention, a detailed description of related known functions or configurations will be omitted to avoid making the essence of the present invention unclear.

In a method for manufacturing a embroidery pattern or a quilting pattern of cloth for an interior panel of a vehicle according to an embodiment of the present invention, by which the embroidery pattern or the quilting pattern is manufactured individually or simultaneously on the cloth, that is, the interior panel for the vehicle by using a computer-aided embroidery machine, only a conventional single product is not quilted but a plurality of products or products of various patterns can be manufactured simultaneously by forming a quilting pattern by using the computer-aided embroidery machine for positioning only a embroidery pattern on the cloth.

A method for manufacturing a embroidery pattern or a quilting pattern of cloth for an interior panel of a vehicle, by which the embroidery pattern or the quilting pattern is formed on the cloth 2 of the interior panel for the vehicle by using a computer-aided embroidery machine 10 having a plurality of pattern heads 3, in which a camera 1 is installed as illustrated in FIGS. 2 and 3, includes, as illustrated in FIG. 1, a step S11 of installing a thread for a embroidery pattern or a quilting pattern, a step S12 of punching a design that is to be applied to the cloth 2, a step S13 of inputting the embroidery pattern or the quilting pattern to a computer, a step S14 of displaying a coordinate recognition mark on the cloth, a step S15 of positioning the cloth on a table, a step S16 of scanning a portion of the embroidery pattern or the quilting pattern of the cloth and transmitting the portion to the computer, by the camera, a step S17 of setting a thread for manufacturing a pattern in a needle support through an operation of the computer, a step S18 of forming the embroidery pattern or the quilting pattern on the cloth, and a step S19 of cutting the cloth.

In the step S11 of installing a thread for a embroidery pattern or a quilting pattern, threads having various colors and thicknesses for forming the embroidery pattern or the quilting pattern on the cloth 2 are in a plurality of thread hangers 4 of the computer-aided embroidery machine 10.

Here, the thread for the embroidery pattern or the quilting pattern includes a single yarn or a folded yarn, it is preferable that the thickness of the thread for the embroidery pattern is 70 to 350 denier, and it is preferable that the thickness of the thread for the quilting pattern is 50 to 380 denier.

In addition, the thread for the quilting pattern is a four-folded polyester filament inner bonding sewing yarn, in which four 70 denier main yarns and one 30 denier central yarn are coupled to each other in a circular form, and the sewing yarn has a high strength and an excellent wear-resistant property and is manufactured through a method disclosed in Korean Patent No. 10-1430870, which was developed by the applicant(s) of the present invention, and a detailed description thereof will be omitted here.

Moreover, the width of stitches of the quilting pattern has various sizes corresponding to the quilting pattern, and preferably is 0.2 to 10.0 mm and is determined in consideration of the aesthetic aspect of the product and the interval between the holes 8 punched in the cloth 2 disclosed below.

In the step S12 of punching a design that is to be applied to the cloth 2, a design for a embroidery pattern or a quilting pattern, which is to be conceived by an operator to be applied, is changed to a form, in which a embroidery or quilting pattern may be made, whereby the conceived design may be easily realized through a embroidery or quilting pattern operation.

That is, the step 12 is an operation process of inputting the kind, the technique, the density, the color degree, the direction of data line needle stitches of a design for a embroidery pattern or a quilting pattern, which is to be applied to the cloth 2 through scanning of the camera 1 so that they are easily delivered to the computer 6.

In the step S13 of inputting the embroidery pattern or the quilting pattern to a computer, a user inputs the embroidery pattern or the quilting pattern, the design of which was punched, to the computer 6 in advance.

Accordingly, if the operator manipulates the embroidery pattern or the quilting pattern input to the computer 6, the color, the thickness, and the stitch width of the threads for the operations are realized in the cloth 2 through the pattern head 3.

The step S14 of displaying a coordinate recognition mark on the cloth is a step of displaying a coordinate recognition mark, which is scanned and recognized by the camera 1 in correspondence to the embroidery pattern or the quilting pattern, on the cloth 2, and if the cloth 2 is moved and the camera 1 recognizes and photographs the mark displayed on the cloth 2 and sends the mark to the computer 6, the computer 6 delivers whether a embroidery pattern or quilting pattern is to be made at a corresponding portion of the cloth 2, to the pattern head 3 to allow the corresponding operation.

In the step S15 of positioning the cloth on a table, the cloth 2, on which the coordinate recognition mark is displayed, is supplied and the cloth 2 is positioned on a table 7.

Furthermore, the cloth 2 positioned on the table 7 is automatically fed to the pattern head 3.

Although the number of the used pattern heads 3 is limited to one to thirty in the present invention, the number or more of pattern heads may be installed and used according to the number of products for forming the embroidery pattern or the quilting pattern.

In the step S16 of scanning a portion of the embroidery pattern or the quilting pattern of the cloth and transmitting the portion to the computer, by the camera, as will be described above, the cloth 3 positioned on the table 7 is supplied to the pattern head 3, the camera 1 scans, recognizes, and photographs a portion, at which the embroidery pattern or the quilting pattern is to be formed by using the coordinate recognition mark, and transmits the scanned and recognized portion to the computer 6, and the computer 6 sends the transmitted data to the pattern head 3 to allow the corresponding operation.

In the step S17 of setting a thread for manufacturing a pattern in a needle support 5 through an operation of the computer, a corresponding thread is selected from the threads of various sizes hung on the thread hangers 4 and the thread is set in a needle support 5 by the computer 6 based on a signal transmitted through the camera 1 such that the embroidery pattern or the quilting pattern is formed on the cloth 2.

Then, the thickness and the color of the corresponding thread follow the form, which is input to the computer 6 in advance in correspondence to the embroidery pattern or the quilting pattern.

In the step S18 of forming the embroidery pattern or the quilting pattern on the cloth as illustrated in FIGS. 4 and 5, the embroidery pattern or the quilting pattern is formed on the cloth 2 by operating the pattern head 3 corresponding to the needle support 5, in which the thread for the embroidery pattern or the quilting pattern is set.

Then, the width of the stitches for the embroidery pattern or the quilting pattern also follows the form input to the computer 6 in advance.

In the step S19 of cutting the cloth 2, the cloth 2, on which the embroidery pattern or the quilting pattern is formed, is cut to a proper form, for example, according to the contour of the seat of the vehicle by using laser CAM cutting or press cutting.

In addition, as illustrated in FIG. 6, the quilting pattern is formed in the form, in which holes 8 are punched in the cloth 2.

That is, in order to form the quilting pattern in the form, in which the plurality of holes 8 are punched in the cloth 2, the camera 1 recognizes the holes 8 and allow the quilting patterns to be made while avoiding the holes 8.

Here, it is preferable that when the diameter of the holes 8 punched in the cloth 2 is 0.5 to 2.5 mm and the distance between the holes 8 is 4 mm the width of the quilting pattern is 4 mm or less.

Further, the embroidery pattern is formed on the cloth in any pattern or any shape regardless of the punched holes 8.

As described above, a embroidery pattern or a quilting pattern is formed in a product, such as a seat of a vehicle, by inputting the size of the product, a embroidery pattern portion in the size, a quilting pattern portion in the size, the color of the embroidery pattern or the quilting pattern, and a cut portion of the product to the computer 6, by scanning and recognizing the corresponding portion in the product and transmitting the scanned and recognized portion to the computer 6, by forming the embroidery pattern or the quilting pattern having a color by operating the pattern head 3 according to a manipulation, by the computer 6 that received the transmitted data, and by cutting the product, in which the embroidery pattern or the quilting pattern is finished, through a cutter or a cutter operated through an operation of the computer 6.

Accordingly, since the embroidery pattern or the quilting pattern can be applied individually or simultaneously to a plurality of pieces of cloth that is an interior panels for vehicles, mass-production is possible, and since various patterns and colors can be formed, an appealing embroidery pattern or quilting pattern can be realized.

As described above, although the present invention has been described with reference to the limited embodiment, the present invention is not limited thereto, and the present invention may be variously corrected and modified by an ordinary person in the art, to which the present invention pertains, without departing from the technical spirit of the present invention and the equivalent scopes of the claims, which will be described above.

1. A method for manufacturing a embroidery pattern or a quilting pattern of cloth for an interior panel of a vehicle, by which the embroidery pattern or the quilting pattern is formed on the cloth (2) of the interior panel for the vehicle by using a computer-aided embroidery machine (10) having a plurality of pattern heads (3), in which a camera (1) is installed, the method comprising:
installing threads having various colors and thicknesses for forming the embroidery pattern or the quilting pattern on the cloth (2) in a plurality of thread hangers (4) of the computer-aided embroidery machine (10);
punching a design of the embroidery pattern or the quilting pattern, which is to be applied to the cloth (2);
inputting the embroidery pattern or the quilting pattern, which is to be applied to the cloth (2), to a computer (6);
displaying a coordinate recognition mark, which is scanned and recognized by the camera (1) in correspondence to the embroidery pattern or the quilting pattern, on the cloth (2);
supplying the cloth (2), on which the coordinate recognition mark is displayed, and positioning the cloth (2) on a table (7);
supplying the cloth (2) positioning on the table (7) to the pattern head (3) to cause the camera (1) to scan and recognize a portion, at which the embroidery pattern or the quilting pattern is to be formed by using the coordinate recognition mark, and transmit the scanned and recognized portion to the computer (6);
selecting a corresponding thread, among the threads of various sizes hung on the thread hangers (4) and setting the thread in a needle support (5) by the computer (6) based on a signal transmitted through the camera (1), to form the embroidery pattern or the quilting pattern on the cloth (2);
forming the embroidery pattern or the quilting pattern on the cloth (2) by operating the pattern head (3) corresponding to the needle support (5), in which the thread for the embroidery pattern or the quilting pattern is set; and
cutting the cloth (2), on which the embroidery pattern or the quilting pattern is formed.

2. The method of claim 1, wherein in order to form the quilting pattern in a form, in which a plurality of holes (8) are punched in the cloth (2), the camera (1) recognizes the holes (8) such that the quilting pattern is formed while avoiding the holes (8).

3. The method of claim 2, wherein when the diameter of the holes (8) punched in the cloth (2) is 0.5 to 2.5 mm and a distance between the holes (8) is 4 mm, the width of the quilting pattern is 4 mm or less.

4. The method of claim 1, wherein the thread for the quilting pattern is a four-folded polyester filament inner bonding sewing yarn, in which four 70 denier main yarns and one 30 denier central yarn are coupled to each other in a circular form.

5. The method of claim 1, wherein the thread for the embroidery pattern or the quilting pattern is a single yarn or a folded yarn, the thickness of the thread for the embroidery pattern is 70 to 350 denier, and the thickness of the thread for the quilting pattern is 50 to 380 denier.

6. The method of claim 1, wherein the width of stitches of the quilting pattern is a size corresponding to the quilting pattern, and is 0.2 to 10.0 mm.

7. The method of claim 1, wherein the embroidery pattern or the quilting pattern is formed on a product of the cloth (2) by:
inputting the size of the product, a portion of the embroidery pattern in the size, a portion of the quilting pattern in the size, the color of the embroidery pattern or the quilting pattern, and a cut portion of the product to the computer (6);
scanning and recognizing corresponding portions of the product and transmitting the corresponding portions to the computer (6), by the camera (1);
operating the pattern head (3) by the computer (6) that received transmitted data according to a manipulation to form the needle pattern or the quilting pattern having a color; and
cutting the product, on which the embroidery pattern or the quilting patter is finished, through a cutter according to an operation of the computer (6).
